(19) United States
(12) Patent Application Publication
(10) Pub. No.: US 2004/0186736 A1
(43) Pub. Date: Sep. 23, 2004

(54) METHOD OF MANAGING SEMICONDUCTOR MANUFACTURING CASES

(76) Inventors: Hung-En Tai, Taipei Hsien (TW); Sheng-Jen Wang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,147

(22) Filed: Mar. 19, 2003

(51) Int. Cl. G06F 17/60

(52) U.S. Cl. 705/1

(57) ABSTRACT

A computer system is employed to manage semiconductor manufacturing cases. After receiving a log-in signal of a user, the computer system opens a case related to a manufacturing process according to an order from the user. Contents, procedures or adjusted results of the manufacturing process is then recorded in the case to form a response report of the case. Finally, after receiving a confirmation message and a signature information related to the response report of the case from the user, the computer system stores the response report of the case and closes the case.

### BACKGROUND OF INVENTION

1. Field of the Invention

The present invention relates to a method of managing semiconductor manufacturing cases, and more specifically, to a method of managing semiconductor manufacturing cases by utilizing a computer system.

2. Description of the Prior Art

In the semiconductor industry, numerous machines are involved in various manufacturing processes. Therefore, it is a primary object for engineers to increase production yield, detect defective procedures and maintain manufacturing machines so as to make products competitive in the market.

However, as technology progresses and competition among semiconductor companies turns to be more and more intense, many enterprises now try to attract engineers in opponent companies by attractive offers in order to strengthen themselves and simultaneously weaken their competitors. In addition, the engineers also tend to change their jobs often. The instability of engineers frequently increase operation cost and researching expense of the company.

Moreover, engineers have to trace back involved manufacturing machines in related processes and adjust improper procedures and parameters in case that the product is inspected to be defective during mess production. Since each product is made by numerous machines and various processes related to different fields, the engineer has to do a lot of research job, which may be already done by another quitted or transferred engineer with research expenditure already spent, in case that the defects are related to an unfamiliar field to the engineer, increasing research expenditures of the company and reducing the manufacturing efficiency of the production line.

In addition, it is often difficult for engineers to find out the results of the previously mentioned research job that had been already done due to the lack of a managing system for files related to different manufacturing processes or the selfishness of the engineer who did the research job holds the related data himself.

Even the results of the previously mentioned research job are found, it might be presented in a specific format that is hard to be understood. As a result, engineers tend to spend additional time and expense to redo the research job without an officially defined schedule. Consequently, the company turns to be less competitive due to the waste of human resources and the increase of the research expenditure.

### SUMMARY OF INVENTION

It is therefore a primary object of managing semiconductor manufacturing cases by utilizing a computer system in order to assure the completeness and readability of cases, and the convenience of employees to search and use the cases.

It is another object of the present invention to provide a platform for users involved in the cases to efficiently and accurately execute the cases as well as to precisely make judgments during manufacturing processes.

It is still another object of the present invention to ensure the cases to be completed on time to improve the production efficiency of the manufacturing processes.

According to the claimed invention, the computer system is employed to manage semiconductor manufacturing cases. After receiving a log-in signal of a user, the computer system opens a case related to a manufacturing process according to an order from the user. Contents, procedures or adjusted results of the manufacturing process is then recorded in the case to form a response report of the case. Finally, after receiving a confirmation message and a signature information related to the response report of the case from the user, the computer system stores the response report of the case and closes the case.

It is an advantage of the present invention against the prior art that the response reports under a same category can be easily searched by the user through either a historic column or a categorizing column of the computer system. Therefore, engineers are able to do the research job related to a specific case on an integrated platform provided by the computer system by utilizing information related to the research topic that is stored in the computer system, so as to improve the processing efficiency and accuracy of the response report. As a result, with the help from the computer system, judgments needed during semiconductor manufacturing can be more precisely made, and training period for engineers can be significantly shortened. Consequently, the company turns to be more competitive in the market.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a block diagram of a computer system utilized in a method of managing semiconductor manufacturing cases according to the present invention.

FIG. 2 is a flow chart of managing semiconductor manufacturing cases in the computer system according to the present invention.

### DETAILED DESCRIPTION

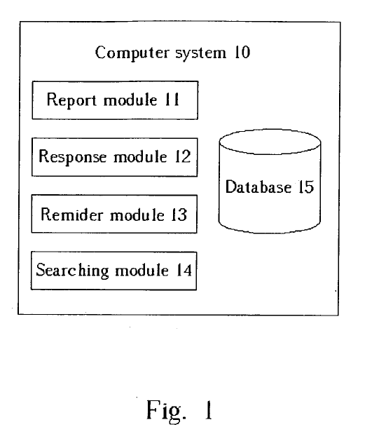

Please refer to FIG. 1 of a block diagram of a computer system 10 utilized in a method of managing semiconductor manufacturing cases according to the present invention. As shown in FIG. 1, the computer system 10 comprises a report module 11, a response module 12, a reminder module 13, a searching module 14 and a database 15. The computer system 10 is employed for a user, either one of a process engineer, a equipment engineer, a system engineer, an integration engineer, a RD engineer or a yield engineer, to manage cases in items related to job functions of the previously mentioned engineers. Operations related to a specific case made by the user are saved in the computer system 10 to form a corresponding response report.

In the present invention, a first document format that comprises a categorizing column is defined in the report module 11 of the computer system 10 to standardize the format of each response report, and only response reports in the first document format can be stored in the computer system 10 for the convenience of managing the response reports. The response module 12 is utilized to manage the user ID, cost, and deadline etc. related to the response report. The reminder module 13 is employed for the purpose of sending message to the user. The searching module 14 is employed for the user to search information, including case ID, ID and department of the user, and key words, related to the response report, set the output format of the searching results, and authorize the user to read, print or save the searched response reports based on a security standard.

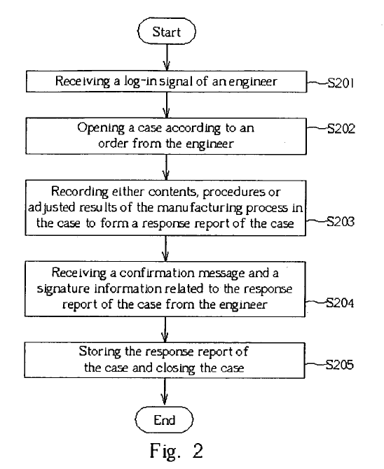

Please refer to FIG. 2 of a flow chart of managing semiconductor manufacturing cases in the computer system 10 according to the present invention. As shown in FIG. 2, the computer system 10 provides an integration platform for engineers involved in the cases to efficiently and accurately execute the cases. First, a step S201 is performed by the computer system to receive a log-in signal from the user, and a step S202 is then performed to open a existent case or create a new case according to an order form the user. Then the user utilizes a corresponding manufacturing machine related to a specific research job to perform a pilot run of the product with a preferred quantity of 2 or 3 batches, and adjust the operation parameters and procedures of the manufacturing machine based on the results of the pilot run. Information related to the contents of the research job, processes employed for the production of the product, adjustments, manufacturing machine, raw materials, production cost, arrangement of human resources and schedule is stored in the opened or the created case previously mentioned to form a response report.

Since more than one user might be involved in the research job, a step S204 is then performed to send the response report to each involved user. A signature information, normally an electronic signature, and a confirmation message related to the response report of the case is then received by the computer system 10 from each of the involved user. Finally, a step S205 is performed by the computer system 10 to close the case after storing the response report of the case in the database 15.

Since there might be numerous manufacturing machines and various processes involved in the production of a single product, the response reports stored in the database 15 need to be categorized for the purpose of being easily searched by the engineers. The categorizing column of the first document format is utilized to categorize the response reports of the semiconductor manufacturing cases, and the computer system 10 is capable of linking portions of the semiconductor manufacturing cases categorized in a same category. As the user orders the computer system 10 to search and open a specific case, or to create a new case, the computer system 10 would spontaneously and simultaneously provide response reports of other cases categorized with this specific case under a same category, preventing the waste of resources of the company.

The categorizing column of the computer system 10 is employed to categorize the response reports of the semiconductor manufacturing cases based on different manufacturing processes, such as lithography, etching, photo, etc. Each category can be further categorized into several sub-categories based on different manufacturing machines or other items. Alternatively, the response reports can be categorized based on departments of the users or specific key words defined by the company. Therefore, the user can easily and precisely search for one or more specific response reports through the categorizing columns in the computer system 10.

In addition, the first document format further comprises a historic data column for recording historic data, which might be a former response report related to the current response report, of the response report. Therefore, the computer system 10 can generate historic linkages between the current response reports and the former reports that are relative to each other, and is capable of simultaneously showing response reports in a same category based on the historic linkages of the opened response report.

Moreover, the response module 12 of the computer system 10 can define a deadline for the response report of each case. In case that the response report is not finished after the deadline, the response module 12 would send either an e-mail or a message to the relative engineers and supervisors via the reminder module 13 in order to improve the processing efficiency of the case.

In comparison with the prior art, the response reports under the same category can be easily searched by the user through either the historic column or the categorizing column of the computer system 10. Therefore, engineers are able to do the research job related to a specific case on the integrated platform provided by the computer system 10 by utilizing information related to the research topic that is stored in the computer system 10, so as to improve the processing efficiency and accuracy of the response report. As a result, with the help from the computer system 10, judgments needed during semiconductor manufacturing can be more precisely made, and training period for engineers can be significantly shortened. Consequently, the company turns to be more competitive in the market.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A method of managing semiconductor manufacturing cases in a computer system comprising:
(A) receiving a log-in signal of a user;
(B) opening a case related to a manufacturing process according to an order from the user;
(C) recording either contents, procedures or adjusted results of the manufacturing process in the case to form a response report of the case;
(D) receiving a confirmation message and a signature information related to the response report of the case from the user; and
(E) storing the response report of the case and closing the case.

2. The method of claim 1 wherein the response report of the case is created by at least one user.

3. The method of claim 2 wherein the adjusted results in the step (C) are generated according to results of pilot runs on the production line.

4. The method of claim 2 wherein the computer system receives the signature information related to the response report of the case from each user in the step (D).

5. The method of claim 4 wherein the signature information is an electronic signature.

6. The method of claim 2 wherein the computer system defines a deadline for the response report of the case and generate a reminding signal for the user if the case is not finished after the deadline.

7. The method of claim 6 wherein the reminding signal is sent to the user by e-mail.

8. The method of claim 2 wherein the response report of the case is formed in a first document format.

9. The method of claim 8 wherein the first document format comprises a categorizing column for categorizing the response reports of the semiconductor manufacturing cases.

10. The method of claim 9 wherein the computer system comprises a linking function to link portions of the semiconductor manufacturing cases categorized in a same category.

11. The method of claim 10 wherein the linking function is employed by the user to search response reports of the semiconductor manufacturing cases categorized in a same category.

12. The method of claim 9 wherein the categorizing column of the computer system is employed to categorize the response reports of the semiconductor manufacturing cases based on key words of the response reports.

13. The method of claim 9 wherein the categorizing column of the computer system is employed to categorize the response reports of the semiconductor manufacturing cases based on departments of the users.

14. The method of claim 8 wherein the first document format comprises a historic data column for recording historic data of the response report.

15. The method of claim 14 wherein the historic data is a former response report related to the response report of the case based on a topic.

16. The method of claim 14 wherein the computer system generate historic linkages between response reports and former reports of the same topic.

17. The method of claim 14 wherein the computer system is capable of showing response reports of the same topic based on the historic linkages of the opened response report.

18. The method of claim 11 wherein the computer system comprises a security function for authorizing the user to read, print or save the searched response reports.
